(19) United States
(12) Patent Application Publication
(10) Pub. No.: US 2008/0162642 A1
(43) Pub. Date: Jul. 3, 2008

(54) Availability Filtering for Instant Messaging

(75) Inventors: Mohamed Bachiri, Melrose, MA (US); Chenita D. Daughtry, Roxbury, MA (US); Robert C. Weir, Westford, MA (US); Carol S. Zimmet, Boxborough, MA (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/617,530

(22) Filed: Dec. 28, 2006

(51) Int. Cl. G06F 15/16

(52) U.S. Cl. 709/206

(57) ABSTRACT

A method and system for filtering instant messages. The instant messages can be received and filtered using multi-factor rules. The multi-factor rules can be associated with a recipient profile.

### BACKGROUND OF THE INVENTION

As use of computer networking has grown over the past decade, so too has the use of instant messaging as a means of communicating. Indeed, the number of active instant messaging users worldwide currently exceeds one hundred million and is growing rapidly. For a variety of reasons, instant messaging is often preferred over placing a traditional telephone call.

One benefit to using instant messaging is that an instant message can be sent to another user virtually instantaneously, while placing a telephone call requires a caller to wait for a connection and for the call to be answered. Moreover, if a call answering system is encountered, the caller may be required to enter additional information in order to reach an intended recipient. Another benefit to using instant messaging is that instant messages can be sent relatively inconspicuously by typing or otherwise entering text into an instant messaging client. In contrast, those using a telephone to communicate sometimes may disturb others with their conversation.

For these and other reasons, those who use computers in the workplace sometimes keep one or more instant messaging clients open on their computers so that they can communicate with others via instant messaging during the workday. There are times, however, when one does not wish to be disturbed with unimportant instant messages, but nonetheless must keep an instant messaging client open to receive important instant messages that may be communicated.

### BRIEF SUMMARY OF THE INVENTION

The present invention is directed to a method of selectively filtering instant messages. The method can include receiving an instant message, identifying a priority of the instant message, and identifying a sender indicator associated with the instant message. The method further can include identifying a recipient profile and conditionally initiating an indicated action in response to the indicated action being identified by the recipient profile as correlating to the priority of the instant message and correlating to the sender indicator.

Another embodiment of the present invention can include a method of prompting a user to enter a recipient profile to be used to filter instant messages. The method can include presenting a graphical user interface screen to the user. The graphical user interface screen can include a first selectable menu item with which the user can select a recipient profile, at least one instance of a second selectable menu item with which the user can select at least one of a plurality of sender indicators, at least one instance of a third selectable menu item with which the user can select at least one of a plurality of priority levels, and at least one instance of a fourth selectable menu item with which the user can select an action to correlate to the selected sender indicator and the selected priority level.

Yet another embodiment of the present invention can include a machine readable storage being programmed to cause a machine to perform the various steps and/or functions described herein.

### BRIEF DESCRIPTION OF THE SEVERAL VIEWS OF THE DRAWINGS

FIG. 1 is a block diagram illustrating a system in accordance with an aspect of the present invention.

FIG. 2 is a flow chart illustrating a method of selectively filtering instant messages.

FIG. 3 is a rules table in accordance with an aspect of the present invention.

FIG. 4 is a rules table in accordance with an aspect of the present invention.

FIG. 5 is a graphical user interface screen in accordance with an aspect of the present invention.

FIG. 6 is a graphical user interface screen in accordance with an aspect of the present invention.

FIG. 7 is a graphical user interface screen in accordance with an aspect of the present invention.

FIG. 8 is a graphical user interface screen in accordance with an aspect of the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment, including firmware, resident software, micro-code, etc., or an embodiment combining software and hardware aspects that may all generally be referred to herein as a “circuit”, “module”, or “system”.

Furthermore, the invention may take the form of a computer program product accessible from a computer-usable or computer-readable medium providing program code for use by, or in connection with, a computer or any instruction execution system. For the purposes of this description, a computer-usable or computer-readable medium can be any apparatus that can contain, store, communicate, propagate, or transport the program for use by, or in connection with, the instruction execution system, apparatus, or device.

Any suitable computer-usable or computer-readable medium may be utilized. The medium can be, for example, but is not limited to, an electronic, magnetic, optical, electromagnetic, infrared, or semiconductor system (or apparatus or device), or a propagation medium. A non-exhaustive list of exemplary computer-readable media can include an electrical connection having one or more wires, an optical fiber, magnetic storage devices such as magnetic tape, a removable computer diskette, a portable computer diskette, a hard disk, a rigid magnetic disk, an optical storage medium, such as an optical disk including a compact disk—read only memory (CD-ROM), a compact disk—read/write (CD-R/W), or a DVD, or a semiconductor or solid state memory including, but not limited to, a random access memory (RAM), a read-only memory (ROM), or an erasable programmable read-only memory (EPROM or Flash memory).

A computer-usable or computer-readable medium further can include a transmission media such as those supporting the Internet or an intranet. Further, the computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber, cable, RF, etc.

In another aspect, the computer-usable or computer-readable medium can be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention relates to multi-factor rules that may be implemented to filter instant messaging requests. Such factors can include the importance of the sender, the urgency of the instant message, and the degree to which the user wishes to be undisturbed. Incoming instant messages can be evaluated according to these factors. Instant messages which meet a particular threshold can be presented to the instant message recipient, while instant messages which do not meet the threshold can be rejected.

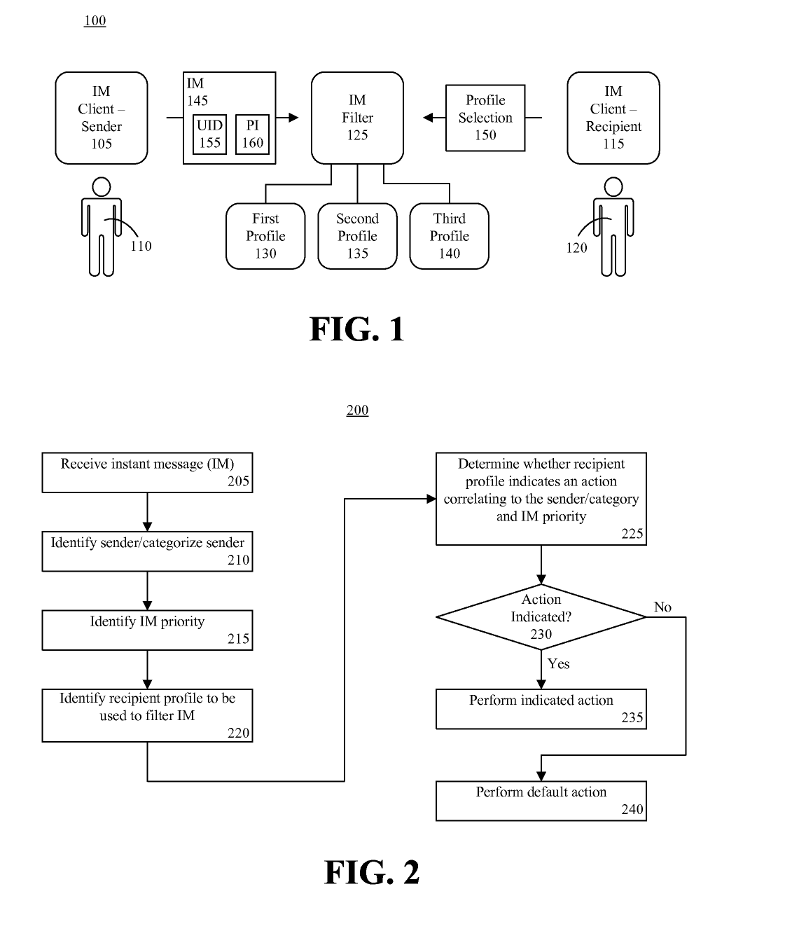

FIG. 1 is a block diagram illustrating a system 100 in accordance with an aspect of the present invention. The system 100 can include an instant message client (hereinafter “IM client”) 105 used by a user 110 who is an instant message sender, and an IM client 115 used by a user 120 who is an instant message recipient. Of course, the user 110 also can receive instant messages, in which case the user 110 would be the recipient, and the user 120 also can send instant messages, in which case the user 120 would be the sender. For simplicity, hereinafter the user 110 will be referred to as the “sender” 110, and the user 120 will be referred to as the “recipient” 120.

The system 100 also can include an instant message multi-factor filter (hereinafter “IM filter”) 125 and a plurality of recipient profiles, for instance a first profile 130, a second profile 135 and a third profile 140. Each of the recipient profiles 130-140 can include rules which may be applied by the IM filter 125 to process instant messages 145 being communicated to the recipient 120. The recipient profiles 130-140 will be discussed herein in greater detail.

In one aspect of the invention, the IM filter 125 can be instantiated on a server which processes instant messages 145 being communicated to the recipient 120. In another arrangement, the IM filter 125 can be instantiated on a processing device on which the IM client 115 is instantiated. Further, the IM filter 125 also can be a component of the IM client 115. Similarly, the recipient profiles 130-140 can be stored on a server, on the processing device on which the IM client 115 is instantiated, or within the IM client 115.

In one arrangement, the specific recipient profile 130-140 that is to be used by the IM filter 125 at a given time can be selected by the recipient 120. For instance, the recipient 120 can select a profile via the IM client 115, and the IM client 115 can communicate the profile selection 150 to the IM filter 125. In another arrangement, the profile selection 150 can be communicated to the IM filter 125 by a system administrator or manager. In yet another arrangement, the specific recipient profile 130-140 that is to be used by the IM filter 125 can be automatically selected by the IM client 115 or the IM filter 125. For example, the recipient profile 130-140 can be automatically selected based upon time (e.g. time of day, day of the week, day of the month, day of the year, week of the month, week of the year and/or month of the year). The recipient profile 130-140 that is selected also can be based on a level of activity detected on the processing device on which the IM client 115 and/or IM filter 125 is instantiated, or in any other suitable manner.

In operation, the IM filter 125 can receive the instant message 145 and apply the selected recipient profile (e.g. the first profile 130) to filter the instant message 145. In particular, the IM filter can process the instant message 145 and apply an action that is selected based on the selected recipient profile 130. For example, the IM filter 125 can reject the instant message, automatically respond to the instant message with a particular response, or communicate the instant message to the IM client 115 for presentation to the recipient 120.

While processing the instant message 145, the IM filter 125 can identify a sender indicator associated with the instant message 145. The sender indicator can comprise, for instance, a user identifier (UI) 155 associated with the sender 110 and/or a sender category with which the sender 110 is associated. Examples of such categories can include work related categories, family related categories, social categories, and the like. The IM filter 125 then can filter the instant message 145 based, at least in part, on the user identifier 155 and/or the sender category. In one arrangement, the IM filter 125 can select the sender category based on user identifier 155.

The IM filter 125 can identify a priority associated with the instant message 145 and filter the instant message 145 based, at least in part, on the identified priority. For example, in one aspect of the invention the instant message 145 can include a priority indicator (PI) 160. The priority indicator 160 can be selected by the sender 110 when generating the instant message 145 via using the IM client 105, or automatically applied to the instant message 145 based on instant messaging settings associated with the sender 110 and/or the IM client 105. For example, the priority indicator 160 can be automatically applied to the instant message 145 based upon the identity of the sender 110, time, a level of activity detected on the processing device on which the IM client 105 and/or IM filter 125 is instantiated, or in any other suitable manner. In one arrangement, the priority indicator 160 can be communicated in the instant message 145 as a flag or data field within a header or footer of the instant message 145.

In another aspect of the invention, the priority of the instant message 145 can be automatically determined based upon the text contained in the instant message 145. For example, text contained in the instant message 145 can be parsed to identify one or more key words or terms in the instant message. A priority indicator that correlates to the identified key word(s) then can be automatically selected and associated with the instant message 145. In such an arrangement, a data file can correlate key words and terms to priority indicators. An example of such a data file can include a database or a hash table, although the invention is not limited in this regard and any suitable data file can be used.

FIG. 2 is a flow chart illustrating a method (200) of selectively filtering instant messages. At step 205, the IM filter can receive an instant message being sent to a recipient. For example, the IM filter can receive an instant messaging request that includes text to be communicated to the recipient and an identifier associated with the sender. At step 210, the IM filter can identify the sender of the instant message and/or categorize the sender. As noted, such identification and/or categorization can be based upon a user identifier associated with the instant message. Proceeding to step 215, a priority of the instant message can be identified. Also as noted, the priority can be identified based upon a priority indicator communicated with the instant message or based upon text contained in the instant message. At step 220 a recipient profile to be used to filter the instant message can be identified. As noted, the recipient profile can be a recipient profile selected by the recipient, automatically selected, or selected in any other suitable manner.

Proceeding to step 225, a determination can be made whether the recipient profile indicates an action correlating to the sender (or the sender's category) and the instant message priority. For example, if the sender is categorized as a manager and the instant message priority indicates that the instant message is critical, a determination can be made whether the recipient profile indicates an action to be implemented when a critical instant message is received from a manager. Referring to decision box 230, if an action is indicated that correlates to the sender (or sender category) and the instant message priority, at step 235 the indicated action can be performed. For instance, the instant message can be communicated to the recipient, the instant message can be rejected, a busy indicator can be communicated to the sender, an offline indicator can be communicated to the sender, or any other suitable action can be implemented. If, however, an action to be performed is not indicated, at step 240 a default action can be performed. In one aspect of the invention, the default action can be indicated by a user preference of the recipient. The default action can be, for instance, to communicate the instant message to the recipient or to reject the instant message.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

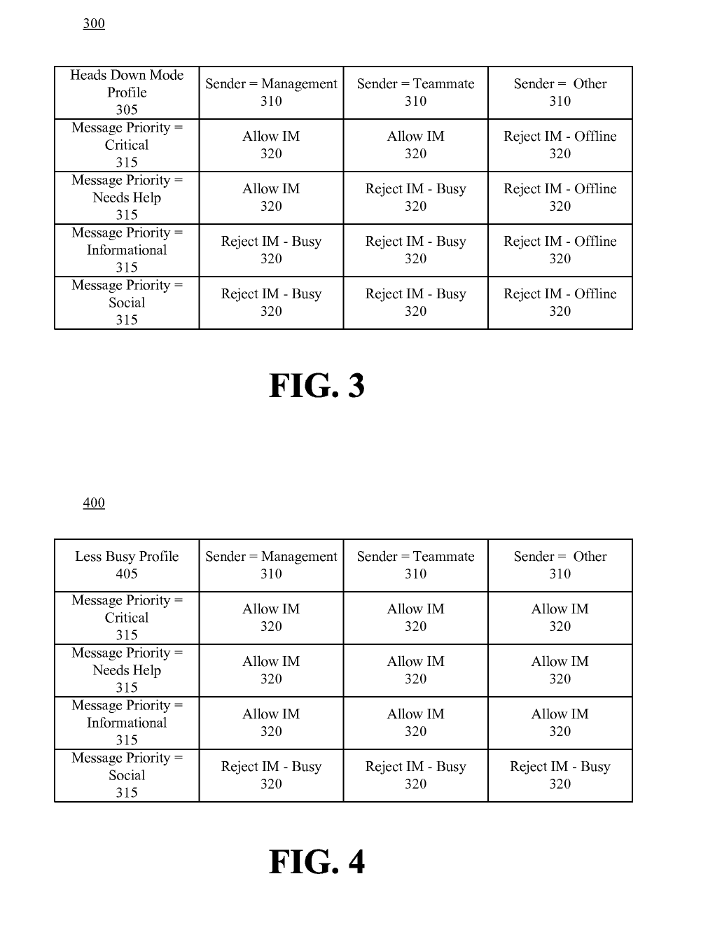

Referring to FIG. 3 a rules table 300 in accordance with an aspect of the present invention is presented. The rules table 300 can indicate multi-factor rules associated with a particular recipient profile 305. The rules can be applied by the IM filter when filtering instant messages while the recipient is operating in the mode indicated by the recipient profile 305. In particular, the rules table 300 can indicate an action 320 to be implemented in response to receiving an instant message from a particular sender (or sender category) 310 having a particular priority level 315. For example, if a “heads down mode” recipient profile 305 has been selected, the sender is a manager 310 and the priority level 315 is critical or requests help, the IM filter can allow the instant message to be communicated to the recipient. If, however, the priority level 315 indicates the instant message is informational or social in nature, the IM filter can reject the instant message and indicate to the sender that the recipient is busy.

Similarly, if the sender is a teammate (e.g. co-worker) of the recipient and the priority level 315 of the instant message is critical, the IM filter can allow the instant message to be communicated to the recipient. If, however, the priority level 315 indicates the instant message requests help, or is informational or social in nature, the IM filter can reject the instant message and indicate to the sender that the recipient is busy. If the sender of the instant message is not a manager or a teammate of the recipient, all instant messages can be rejected by the IM filter and the IM filter can indicate to the sender that the recipient is offline.

FIG. 4 is another rules table 400 in accordance with an aspect of the present invention. The rules table 400 can indicate rules to be applied by the IM filter when a “less busy” recipient profile 405 has been selected. Using this profile 405, the IM filter can allow communication to the recipient of all instant messages having a priority level 315 indicating that the instant message is critical, the sender needs help, or that the instant message is informational in nature. All instant messages which are prioritized as social in nature can be rejected by the IM filter and the IM filter can indicate to the sender that the recipient is busy.

At this point it should be noted that the rules tables 300, 400 presented in FIG. 3 and FIG. 4, respectively, are merely examples of multi-factor rules that can be implemented to filter instant messages. A myriad of other multi-factor rule sets also can be implemented. For instance, rules can be established for specific individuals and/or other categories 310 of people. Examples of such categories can include, but are not limited to, relatives, spouses, children, siblings, friends, close friends, acquaintances, high-level managers, mid-level managers, low-level managers, high-level subordinates, mid-level subordinates, low-level subordinates, vendors, clients, customers, and so on.

Moreover, a greater number or fewer priority levels 315 can be included in the multi-factor rule sets. For instance, in lieu of, or in addition to, any of the priority levels indicated in the rules tables 300, 400, other priority levels can be provided. Examples of such priority levels can include, but are not limited to, “question,” “urgent,” “client related,” “customer related,” “product related,” etc.

Further, other actions 320 to be implemented can be identified in the rules tables 300, 400. Examples of such actions can include, but are not limited to, storing a sender identifier for senders who sent instant messages that were blocked by the IM filter, storing the instant messages blocked by the IM filter, providing a custom response to a sender in response to an instant message being blocked, delegating or transferring the message to a designated alternate recipient, and so on. In an arrangement in which sender identifiers and/or blocked instant messages are stored, such information can be communicated to the intended recipient at a later time or at the request of the recipient. For example, at the end of a work day a recipient can peruse a list of instant messages that were blocked earlier in the day.

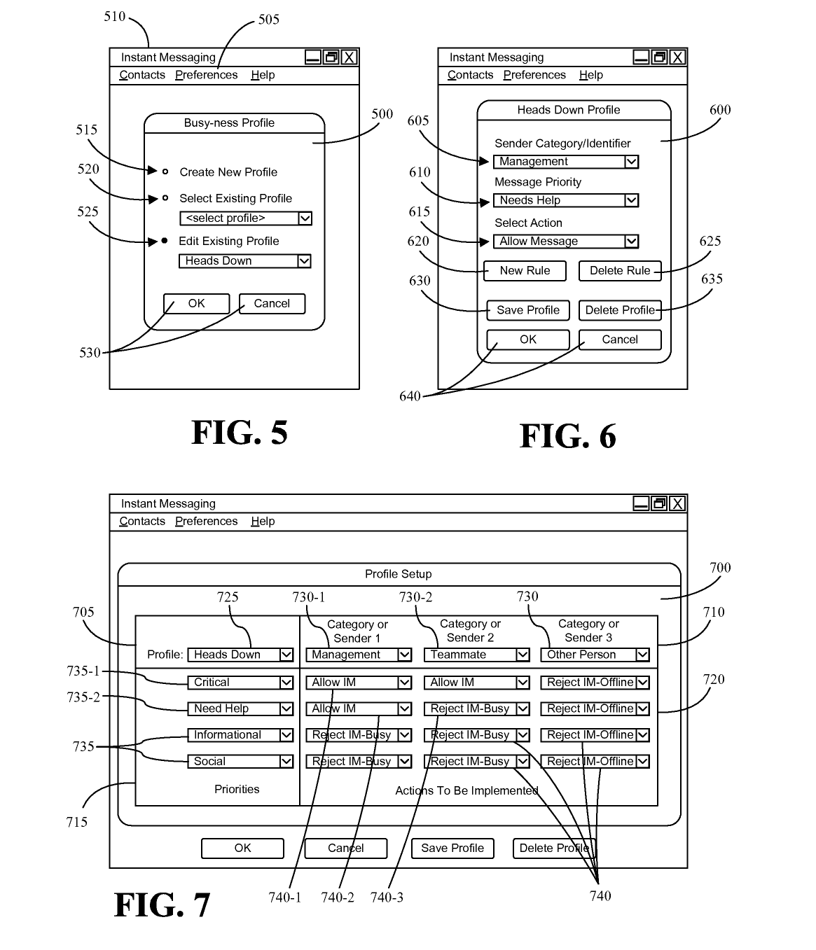

FIG. 5 depicts a graphical user interface screen (hereinafter “screen”) 500 which may be activated to enter a recipient profile. The screen 500 can be activated, for instance, via a menu item 505 provided in an instant messaging user interface 510. The screen 500 can include a selectable menu item 515 to create a new recipient profile, a selectable menu item 520 to select an existing recipient profile, and a selectable menu item 525 to edit an existing recipient profile. The menu items 515-525 can be selected using radio buttons, selectable icons, or in any other suitable manner. In addition, the screen 500 also can include any other menu items 530, for instance “OK” and “Cancel.” If a user of the screen 500 selects the menu item 515 to create a new recipient profile or the menu item 525 to edit an existing recipient profile, a screen 600 depicted in FIG. 6 can be presented to the user.

The user may interface with the screen 600 to define one or more rules contained in a particular recipient profile. For example, the screen 600 can present a menu item 605 which may be used to select a sender category (or sender identifier), a menu item 610 which may be used to select an instant message priority, and a menu item 615 which may be used to select an action to be associated with the selected sender identifier/category and the selected instant message priority. In one arrangement, the menu items 605-615 can receive user defined rule factors, for instance user defined sender categories/identifiers, instant message priorities and/or actions.

Selectable menu items also can be provided to perform various other operations. Examples of such selectable menu items can include, but are not limited to, a selectable menu item 620 to define a new rule, a selectable menu item 625 to delete a rule, a selectable menu item 630 to save a recipient profile, a selectable menu item 635 to delete a recipient profile, and other menu items 640.

FIG. 7 depicts another screen 700 that may be presented to a user for creating and editing recipient profiles. The screen 700 may be presented in lieu of the screen 600. The screen 700 can include a plurality of screen sections 705, 710, 715, 720. The screen section 705 can include a selectable menu item 725 with which a user can select an existing recipient profile or create a new recipient profile. For example, the selectable menu item 725 can include a drop-down menu that presents identifiers for existing recipient profiles, as well as an identifier that can be selected to create a new recipient profile.

The screen section 710 can include a plurality of instances of selectable menu items 730 with which the user can select one or more senders or categories of senders that are to be associated with one or more multi-factor rules. The selectable menu items 730 also can include drop-down menus that present identifiers for existing senders or sender categories, as well as identifiers that can be selected to create new senders or sender categories. In the screen 700, the selectable menu items 730 can be positioned as column headers of a two-dimensional grid (as shown), or as row headers of the two-dimensional grid.

The screen section 715 can include a plurality of instances of selectable menu items 735 with which the user can select instant message priority levels, each of which may be selected to be associated with one or more multi-factor rules. The selectable menu items 735 also can include drop-down menus that present identifiers for available priority levels. In an arrangement in which the user can define priority levels, selectable identifiers can be presented to enable a user to define a new priority level. In the screen 700, the selectable menu items 735 can be positioned as row headers of the two-dimensional grid (as shown), or as column headers of the two-dimensional grid.

The screen section 720 can include a plurality of instances of selectable menu items 740 with which the user can select one or more actions to be implemented, for example by the IM filter. Each of the actions can be associated with a particular priority level and a particular sender or sender category. For instance, an action identified in a particular menu item 740-1 can correspond to the sender or category identified in the menu item 730-1 with which the menu item 740-1 is vertically (or horizontally) aligned, and such action also can correspond to the priority level identified in the menu item 735-1 with which the menu item 740-1 is horizontally (or vertically) aligned. Similarly, an action identified in a menu item 740-2 can correspond to the sender or category identified in the menu item 730-1 with which the menu item 740-2 is vertically (or horizontally) aligned, and such action also can correspond to the priority level identified in the menu item 735-2 with which the menu item 740-2 is horizontally (or vertically) aligned. Further, an action identified in a menu item 740-3 can correspond to the sender or category identified in the menu item 730-2 with which the menu item 740-3 is vertically (or horizontally) aligned, and such action also can correspond to the priority level identified in the menu item 735-2 with which the menu item 740-3 is horizontally (or vertically) aligned.

Such a scheme for associating actions with specific priority levels and senders/categories can facilitate creation and editing of recipient profiles. As previously indicated for other menu items, the selectable menu items 740 also can include drop-down menus that present identifiers for available actions. In an arrangement in which the user can define actions, selectable identifiers can be presented to enable a user to define a new action to be implemented.

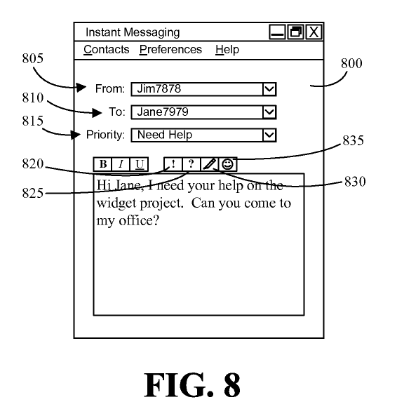

FIG. 8 depicts a screen 800 which may be presented to an instant message sender for composing instant messages. In one arrangement, the screen can include a selectable menu item 805 to indicate an identifier for the sender of the instant message, and a selectable menu item 810 to indicate an identifier for the recipient of the instant message. In lieu of presenting the selectable menu item 805, however, the identifier for the sender of the instant message can be determined based upon a login screen (not shown). Similarly, the recipient of the instant message can be determined prior to presentation of the screen 800, in which case the selectable menu item 810 would not be needed.

Regardless of whether the selectable menu items 805, 810 are presented in the screen 800, a selectable menu item 815 can be provided to indicate the priority of the instant message that is to be generated. For example, the selectable menu item 815 can comprise a drop-down menu that includes a plurality of selectable priority indicators from which the sender may choose. In lieu of the menu item 815, or in addition to the menu item 815, the screen 800 can include a plurality of selectable buttons or icons 820, 825, 830, 835 that may be selected to indicate instant message priority. For instance, the first button 820 can be selected to indicate that the instant message is critical or high priority, the second button 825 can be selected to indicate that the instant message pertains to a request for help, the third button 830 can be selected to indicate that the instant message is informational in nature, and the fourth button 835 can be selected to indicate that the instant message is social in nature. Notwithstanding, it will be appreciated that these are only examples of buttons or icons that can be provided and buttons or icons can be presented to indicate any type of instant message priority that may be applicable.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to the embodiments thereof, it will be apparent that modifications and variations are possible without departing from the scope of the invention defined in the appended claims.

What is claimed is:

1. A method of selectively filtering instant messages, comprising:
receiving an instant message;
identifying a priority of the instant message;
identifying a sender indicator associated with the instant message;
identifying a recipient profile; and
conditionally initiating an indicated action in response to the indicated action being identified by the recipient profile as correlating to the priority of the instant message and correlating to the sender indicator.

2. The method of claim 1, further comprising:
conditionally initiating a default action in response to the indicated action not being identified.

3. The method of claim 1, wherein identifying the priority of the instant message comprises identifying a priority indicator associated with the instant message.

4. The method of claim 3, wherein identifying the priority indicator associated with the instant message comprises parsing the priority indicator from the instant message.

5. The method of claim 1, wherein identifying the priority of the instant message comprises:
parsing text contained in the instant message;
identifying at least one key word in the instant message; and
identifying a priority indicator that correlates to the identified key word.

6. The method of claim 1, wherein identifying the sender indicator comprises identifying an identifier associated with the sender.

7. The method of claim 1, wherein identifying the sender indicator comprises identifying a sender category with which the sender is associated.

8. The method of claim 1, wherein identifying a recipient profile comprises identifying a recipient profile selected by an instant message recipient.

9. The method of claim 1, further comprising prompting an instant message recipient to enter the recipient profile.

10. The method of claim 9, wherein prompting the instant message recipient to enter the recipient profile comprises:
presenting a graphical user interface screen to the recipient, the graphical user interface screen comprising:
a first selectable menu item with which the recipient can select the recipient profile;
at least one instance of a second selectable menu item with which the recipient can select at least one of a plurality of sender indicators;
at least one instance of a third selectable menu item with which the recipient can select at least one of a plurality of priority levels; and
at least one instance of a fourth selectable menu item with which the recipient can select an action to correlate to the selected sender indicator and the selected priority level.

11. The method of claim 10, further comprising:
positioning a plurality of instances of the second selectable menu item as column headers of a two-dimensional grid;
positioning a plurality of instances of the third selectable menu item as row headers of the two-dimensional grid; and
positioning a plurality of instances of the fourth selectable menu item in the two-dimensional grid, each instance of the fourth selectable menu item corresponding to the second selectable menu item with which it is vertically aligned and corresponding to the third selectable menu item with which it is horizontally aligned.

12. The method of claim 10, further comprising:
positioning a plurality of instances of the second selectable menu item as row headers of a two-dimensional grid;
positioning a plurality of instances of the third selectable menu item as column headers of the two-dimensional grid; and
positioning a plurality of instances of the fourth selectable menu item in the two-dimensional grid, each instance of the fourth selectable menu item corresponding to the second selectable menu item with which it is horizontally aligned and corresponding to the third selectable menu item with which it is vertically aligned.

13. The method of claim 1, further comprising prompting the sender of the instant message to indicate the priority of the instant message.

14. The method of claim 13, wherein prompting the sender of the instant message to indicate the priority of the instant message comprises presenting a graphical user interface screen to the sender, the graphical user interface screen comprising a selectable menu item with which the sender can select a priority level to assign to the instant message.

15. A method for prompting a user to enter a recipient profile to be used to filter instant messages, comprising:
presenting a graphical user interface screen to the user, the graphical user interface screen comprising:
a first selectable menu item with which the user can select a recipient profile;
at least one instance of a second selectable menu item with which the user can select at least one of a plurality of sender indicators;
at least one instance of a third selectable menu item with which the user can select at least one of a plurality of priority levels; and
at least one instance of a fourth selectable menu item with which the user can select an action to correlate to the selected sender indicator and the selected priority level.

16. The method of claim 15, further comprising:
positioning a plurality of instances of the second selectable menu item as column headers of a two-dimensional grid;
positioning a plurality of instances of the third selectable menu item as row headers of the two-dimensional grid; and
positioning a plurality of instances of the fourth selectable menu item in the two-dimensional grid, each instance of the fourth selectable menu item corresponding to the second selectable menu item with which it is vertically aligned and corresponding to the third selectable menu item with which it is horizontally aligned.

17. The method of claim 15, further comprising:
positioning a plurality of instances of the second selectable menu item as row headers of a two-dimensional grid;
positioning a plurality of instances of the third selectable menu item as column headers of the two-dimensional grid; and
positioning a plurality of instances of the fourth selectable menu item in the two-dimensional grid, each instance of the fourth selectable menu item corresponding to the second selectable menu item with which it is horizontally aligned and corresponding to the third selectable menu item with which it is vertically aligned.

18. A computer program product comprising:
a computer usable medium having computer usable program code that selectively filters instant messages, said computer program product including:
computer usable program code that receives an instant message;
computer usable program code that identifies a priority of the instant message;
computer usable program code that identifies a sender indicator associated with the instant message;
computer usable program code that identifies a current recipient profile; and
computer usable program code that conditionally initiates an indicated action in response to the indicated action being identified by the recipient profile as correlating to the priority of the instant message and correlating to the sender indicator.

19. The computer program product of claim 18, further comprising:
computer usable program code that presents a graphical user interface screen to an instant message recipient, the graphical user interface screen comprising:
a first selectable menu item with which the recipient can select the recipient profile;
at least one instance of a second selectable menu item with which the recipient can select at least one of a plurality of sender indicators;
at least one instance of a third selectable menu item with which the recipient can select at least one of a plurality of priority levels; and
at least one instance of a fourth selectable menu item with which the recipient can select an action to correlate to the selected sender indicator and the selected priority level.

20. The computer program product of claim 19, wherein the computer usable program code that presents the graphical user interface screen to the instant message recipient further comprises:
code that positions a plurality of instances of the second selectable menu item as column headers or row headers of a two-dimensional grid;
code that positions a plurality of instances of the third selectable menu item as row headers or column headers of the two-dimensional grid; and
code that positions a plurality of instances of the fourth selectable menu item in the two-dimensional grid, each instance of the fourth selectable menu item corresponding to the second selectable menu item with which it is vertically or horizontally aligned and corresponding to the third selectable menu item with which it is horizontally or vertically aligned.
